(19) United States
(12) Patent Application Publication
(10) Pub. No.: US 2009/0200362 A1
(43) Pub. Date: Aug. 13, 2009

(54) METHOD OF MANUFACTURING A SEMICONDUCTOR PACKAGE

(76) Inventors: Ky-Hyun JUNG, Cheonan-si (KR); Jae-Yong Park, Cheonan-si (KR); Heui-Seog Kim, Cheonan-si (KR); Wha-Su Sin, Cheonan-si (KR); Jung-Hyeon Kim, Hwaseong-si (KR)

Correspondence Address: STANZIONE & KIM, LLP, 919 18TH STREET, N.W., SUITE 440, WASHINGTON, DC, 20006, US

(21) Appl. No.: 12/369,257

(22) Filed: Feb. 11, 2009

(30) Foreign Application Priority Data
Feb. 11, 2008 (KR) 2008-12188

(51) Int. Cl. B23K 31/02; B23K 1/20

(52) U.S. Cl. 228/179.1; 228/245; 228/256; 228/203

(57) ABSTRACT

In a lead-free solder, a semiconductor package and a method of manufacturing the semiconductor package, the lead-free solder includes about 3.5 percent by weight to about 6 percent by weight of silver, about 0.05 percent by weight to about 0.5 percent by weight of copper and a remainder of tin. The lead-free solder is employed in the semiconductor package. The lead-free solder has high impact resistance and high heat resistance to reduce failures of the semiconductor package.

### CROSS-REFERENCE TO RELATED APPLICATIONS

This application claims priority under 35 U.S.C. §119 to Korean Patent Application No. 2008-12188, filed on Feb. 11, 2008 in the Korean Intellectual Property Office (KIPO), the contents of which are herein incorporated by reference in their entirety.

### BACKGROUND

1. Field of the General Inventive Concept

Example embodiments relate to a lead-free solder, a semiconductor package including the lead-free solder, and a method of manufacturing the semiconductor package including the lead-free solder. More particularly, example embodiments relate to a lead-free solder having improved impact characteristics, a semiconductor package including the lead-free solder, and a method of manufacturing the semiconductor package including the lead-free solder.

2. Description of the Related Art

Semiconductor packages have been developed in recent years such that semiconductor chips having different functions can be mounted in different ways. External connection terminals of the semiconductor packages are changing from lead connectors to solder balls.

Meanwhile, as a greater emphasis is placed on global environment issues, it is now becoming less desirable to use tin/lead-based solders, and thus lead-free solders including silver (Ag), tin (Sn) and copper (Cu), such as tin/silver/copper-based solders, are widely used in a packaging process of a semiconductor device. Impact resistance and heat resistance in relation to solder joint reliability are required in semiconductor packages because the semiconductor packages are employed in electronic devices such as mobile phones, the auto industry, the aerospace industry, etc.

When a conventional solder is used in a semiconductor package, the semiconductor package has good heat resistance. However, as illustrated in FIG. 1, when the conventional solder 10 is mounted on a solder pad 20 in the semiconductor package, a fragile intermetallic compound layer 12 is formed at an interface between the conventional solder 10 and the solder pad 20 to generate cracks 14 in the solder joint 16. When a solder has a low content of silver, heat resistance is deteriorated due to the low content of silver, although impact resistance is increased.

### SUMMARY

The present general inventive concept provides a lead-free solder including silver (Ag) and copper (Cu). The lead-free solder may have improved impact resistance and improved heat resistance.

The present general inventive concept also provides a semiconductor package including the lead-free solder having improved impact resistance and improved heat resistance.

The present general inventive concept also provides a method of manufacturing the semiconductor package including the lead-free solder having improved impact resistance and improved heat resistance.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a lead-free solder including silver (Ag) of about 3.5 percent by weight to about 6 percent by weight copper (Cu) of about 0.05 percent by weight to about 0.5 percent by weight and tin (Sn) as a remainder.

The lead-free solder may include silver of about 3.5 percent by weight to about 5 percent by weight, copper of about 0.1 percent by weight to about 0.4 percent by weight and tin as a remainder. The lead-free solder may be processed to have a bar shape or a ball shape. The lead-free solder may be processed into a paste. The lead-free solder may be employed for a purpose of manufacturing semiconductor packages and electronic devices.

The lead-free solder may include silver of about 3.5 percent by weight to about 4.5 percent by weight, copper of about 0.1 percent by weight to about 0.2 percent by weight and tin as a remainder.

The foregoing and/or other aspects and utilities of the present general inventive concept may be achieved by providing a semiconductor package including a first printed circuit board (PCB) having a first solder pad, a first lead-free solder mounted on the first solder pad and at least one semiconductor chip electrically connected to the first PCB. The first lead-free solder includes silver of about 3.5 percent by weight to about 6 percent by weight, copper of about 0.05 percent by weight to about 0.5 percent by weight and tin as a remainder. The semiconductor package may include a second lead-free solder mounted on the second solder pad.

The first lead-free solder may have a number of drop impacts of about 105 times to about 211 times in performing a drop impact test.

The semiconductor package may include a second PCB electrically connected to the first lead-free solder and a second lead-free solder mounted on a second solder pad, which is included in the second PCB.

The foregoing and/or other aspects and utilities of the present general inventive concept may be achieved by providing a method of manufacturing a semiconductor package. In the method, a first PCB having a first solder pad is prepared. At least one semiconductor chip is electrically connected to the first PCB. A first lead-free solder is mounted on the first solder pad. The first lead-free solder includes silver of about 3.5 percent by weight to about 6 percent by weight, copper of about 0.05 percent by weight to about 0.5 percent by weight and tin as a remainder.

A second PCB may be connected to the first lead-free solder. The second PCB may include a second solder pad.

A second lead-free solder may be mounted on the second solder pad.

The foregoing and/or other aspects and utilities of the present general inventive concept may be achieved by providing a lead-free solder ball which may include a first quantity of silver (Ag), a second quantity of copper (Cu), and a third quantity of tin (Sn), wherein amounts of the first and second quantities improve the heat resistance, impact resistance, and flexibility of the lead-free solder ball. The first quantity of silver (Ag) may be about 3.5 percent by weight to about 6 percent by weight of the lead-free solder ball. The second quantity of copper (Cu) may be about 0.05 percent by weight to about 0.5 percent by weight of the lead-free solder ball.

The foregoing and/or other aspects and utilities of the present general inventive concept may be achieved by providing a semiconductor package apparatus which may include a plurality of first solder balls having a first diameter, a plurality of first solder pads disposed over the plurality of first solder balls, a first photo solder resist pattern interspersed between the plurality of first solder pads, a printed circuit board disposed over the plurality of first solder pads, a plurality of second solder pads disposed over the printed circuit board, a second photo solder resist pattern interspersed between the plurality of second solder pads, and a plurality of second solder balls having a second diameter substantially larger than the first diameter.

The foregoing and/or other aspects and utilities of the present general inventive concept may be achieved by providing a method of forming a lead-free solder ball, including forming a lead-free solder ball including silver (Ag) of about 3.5 percent by weight to about 6 percent by weight, copper (Cu) of about 0.05 percent by weight to about 0.5 percent by weight, and tin (Sn) as a remainder.

The foregoing and/or other aspects and utilities of the present general inventive concept may be achieved by providing a method of forming a semiconductor package apparatus, including forming a lead-free solder ball on a printed circuit board with a semiconductor chip, wherein the lead-free solder ball includes silver (Ag) of about 3.5 percent by weight to about 6 percent by weight, copper (Cu) of about 0.05 percent by weight to about 0.5 percent by weight, and tin (Sn) as a remainder.

The foregoing and/or other aspects and utilities of the present general inventive concept may be achieved by providing a method of manufacturing a semiconductor package which may include forming a layer of photo solder resist with at least one opening, forming at least one solder pad within the at least one opening, adhering a lead-free solder ball to the at least one solder pad, and coating a water-soluble antioxidant to the at least one solder pad to prevent oxidation of the at least one solder pad.

The foregoing and/or other aspects and utilities of the present general inventive concept may be achieved by providing a method of testing a semiconductor package which may include performing a drop-impact test which may include mounting a semiconductor device package having a lead-free solder ball as a connecting terminal on a sample, loading the sample into equipment for the drop-impact test, and dropping the sample from a predetermined height toward a rigid base to obtain an impact force applied to the sample from the rigid base. The samples may be dropped face down. The samples may be dropped by an acceleration of gravity of about 1,500 g/ms toward the rigid base to apply the impact force.

The foregoing and/or other aspects and utilities of the present general inventive concept may be achieved by providing a method of testing a semiconductor package may include dropping a PCB module until a first failure to correspond to cracking of an intermetallic compound layer between a lead-free solder ball and a solder pad is generated.

The foregoing and/or other aspects and utilities of the present general inventive concept may be achieved by providing a lead-free solder including copper having less than about 0.5 percent by weight and silver having more than about 3.5 percent by weight may have high impact resistance and good heat resistance. Thus, semiconductor packages and electronic devices may have improved solder joint reliability to reduce failures of the semiconductor packages and the electronic devices.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a scanning electron microscope (SEM) picture illustrating an intermetallic compound layer of a solder joint after performing a drop impact test with respect to a conventional semiconductor package.

FIG. 2 is a cross-sectional view illustrating a stacked semiconductor package according to an embodiment of the present general inventive concept.

FIG. 3 is a cross-sectional view illustrating a lower solder joint of the stacked semiconductor package according to an embodiment of the present general inventive concept.

FIG. 4 is a cross-sectional view illustrating a semiconductor module including a solder according to an embodiment of the present general inventive concept.

FIG. 5 is a graph illustrating the results of a drop impact test according to a content of components included in a solder.

FIG. 6A illustrates an enlarged view of a lead-free solder ball apparatus bordered on two sides by photo solder resist according to an embodiment of the present general inventive concept.

FIG. 6B illustrates an enlarged view of a lead-free solder ball apparatus bordered on one side by a photo solder resist according to an embodiment of the present general inventive concept.

FIG. 7 illustrates an electronic apparatus according to an embodiment of the present general inventive concept.

FIG. 8 illustrates an electronic apparatus according to another embodiment of the present general inventive concept.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, the element or layer may be directly on, connected to, coupled with, or coupled to another element or layer, through intervening elements or layers. In contrast, when an element is referred to as being “directly on,” “directly connected to” or “directly coupled to” another element or layer, there are no intervening elements or layers present. In this disclosure, numerals refer to like elements throughout. As used herein, the term “and/or” may include any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present general inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other angles or orientations) and the spatially relative descriptors used herein interpreted accordingly.

The terminology used herein is for the purpose of describing particular example embodiments only and is not intended to be limiting of the present general inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present general inventive concept.

Unless otherwise defined, all terms (including technical and scientific terms) used herein have the same meaning as commonly understood by one of ordinary skill in the art to which this present general inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

Lead-Free Solder

A lead-free solder includes about 3.5 percent by weight to about 6 percent by weight of silver (Ag), about 0.05 percent by weight to about 0.5 percent by weight of copper (Cu) and a remainder of tin (Sn).

Silver included in the lead-free solder may improve heat resistance and impact resistance and increase the flexibility of the lead-free solder. When the lead-free solder includes less than about 3.5 percent by weight of silver, the thermal conductivity and the electrical conductivity of the lead-free solder may be insufficient for practical use and the heat resistance may be deteriorated despite increasing the impact resistance. When the lead-free solder includes more than about 6 percent by weight of silver, costs may be increased without improving the heat resistance compared to that of the lead-free solder including about 6 percent by weight of silver. Thus, the lead-free solder includes about 3.5 percent by weight to about 6 percent by weight of silver. In one example embodiment, the lead-free solder may include about 3.5 percent by weight to about 5 percent by weight of silver. In another embodiment, the lead-free solder may include about 3.5 percent by weight to about 4.5 percent by weight of silver.

Copper included in the lead-free solder may improve the tensile strength and impact resistance of the lead-free solder. When the lead-free solder includes less than about 0.05 percent by weight of copper, the impact resistance of the lead-free solder may be reduced. When the lead-free solder includes more than about 0.5 percent by weight of copper, the heat resistance of the lead-free solder may be reduced without increasing the impact resistance. Thus, the lead-free solder includes about 0.05 percent by weight to about 0.5 percent by weight of copper. In one example embodiment, the lead-free solder may include about 0.1 percent by weight to about 0.4 percent by weight of copper. In another example embodiment, the lead-free solder may include about 0.1 percent by weight to about 0.2 percent by weight of copper.

Tin included in the lead-free solder may lower the melting point of a base material mounted on the lead-free solder and affect the manufacturing cost of the lead-free solder. When the lead-free solder includes an excessive amount of tin or an insufficient amount of tin, the melting point of the lead-free solder may be increased to deteriorate characteristics of the lead-free solder in a soldering process. As a result, the durability of the semiconductor package may be deteriorated.

The lead-free solder described above may be processed to be employed in a semiconductor package or an electronic device. In example embodiments, the lead-free solder having the above-mentioned content may be processed into a paste. For example, the lead-free solder may be processed to have a bar shape or a ball shape.

The above-mentioned content of the lead-free solder may be determined by considering characteristics of the lead-free solder. When an alloy used to form the lead-free solder is dissolved during the soldering process, a metal included in the alloy such as tin, silver, copper, etc. may react with oxygen in the atmosphere to form a metal oxide. The metal oxide may deteriorate adhesion between a printed circuit board (PCB) and elements and cause a loss of the metal used to form the lead-free solder during the soldering process. The metal oxide may generate cracks in the lead-free solder due to impacts and heat after the soldering process. In example embodiments, the lead-free solder having the above-mentioned content may not be oxidized during the soldering process.

The lead-free solder described above may have a temperature difference of about 10° C. between a liquidus curve and a solidus curve to thereby be efficiently dissolved within a narrow temperature range. Abrupt changes of a thermal expansion coefficient caused by a temperature difference between a liquid state and a solid state and thermal modification of an electronic device may be reduced to enable stable operation. Therefore, the lifespan of products may be extended and the products may also have high impact resistance and good heat resistance.

Semiconductor Package

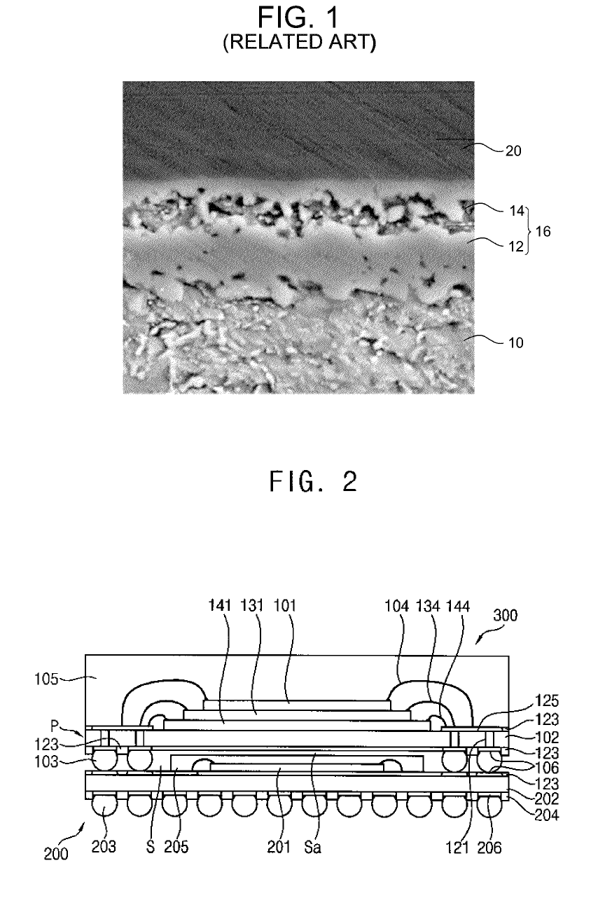

FIG. 2 is a cross-sectional view illustrating a stacked semiconductor package according to an embodiment of the present general inventive concept.

Referring to FIG. 2, the stacked semiconductor package 300 includes a first PCB 102 and at least one semiconductor chip 101 such as a memory semiconductor chip, a large-scale integration (LSI) semiconductor chip, etc. The at least one semiconductor chip 101 may include a first semiconductor chip 101, a second semiconductor chip 131 and a third semiconductor chip 141 of varying functionalities. However, the present general inventive concept is not limited thereto. The semiconductor chip package 300 may include a number of semiconductor chips depending on the desired function of the chip package 300. The number of semiconductor chips may be two, three, or more. The semiconductor chips 101, 131 and 141 may be electrically connected to the first PCB 102 by bonding wires 104, 134 and 144 respectively. In an example embodiment, the stacked semiconductor package 300 may include a multi-chip package (MCP) in which the semiconductor chips 101, 131 and 141 are vertically stacked. The semiconductor chips 101, 131, 141 and the bond wires 104, 134, and 144 may be sealed and protected from the outside environment by an encapsulating layer 105.

The first PCB 102 may include a flexible substrate, a rigid substrate, etc. The first PCB 102 may include polyimide, an epoxy-based resin, polyethylene, etc. For example, the first PCB 102 may include the flexible substrate including polyimide, the rigid substrate including polyethylene or an epoxy resin, etc.

The first PCB 102 has a solder pad 106. The solder pad 106 may be electrically insulated from one another by a photo solder resist 123 including an insulation material.

An epoxy mold compound or encapsulating layer 105 may mold or encapsulate a portion of the first PCB 102, the semiconductor chip 101 and the bonding wires 104, 134 and 144. A lead-free solder 103 is mounted on the solder pad 106 of the first PCB 102.

The lead-free solder 103 is formed using an alloy including about 3.5 percent by weight to about 6 percent by weight of silver (Ag), about 0.05 percent by weight to about 0.5 percent by weight of copper (Cu) and a remainder of tin. The lead-free solder 103 may be electrically connected to at least one of the semiconductor chips 101, 131 and 141 by the solder pad 106 through a via hole 121, a metal line 125 and at least one of the bonding wires 104, 134 and 144. In an example embodiment, the lead-free solder 103 may be processed to have a ball shape. The lead-free solder 103 including less than about 0.5 percent by weight of copper and more than about 3.5 percent by weight of silver may have sufficient impact resistance. The lead-free solder 103 having the above-mentioned content may have a substantially higher heat resistance compared to that of a solder including about 0.1 percent by weight of silver, about 0.5 percent by weight of copper and a remainder of tin. The above-mentioned content of the lead-free solder 103 has already been described above, so any further explanations will be omitted herein for brevity.

The lead-free solder ball 103 stacked semiconductor package 300 may contain tin, silver and copper to be mounted on the solder pad 106. The stacked semiconductor package 300 may be mounted on a second PCB 202 of another ball grid array (BGA) package 200.

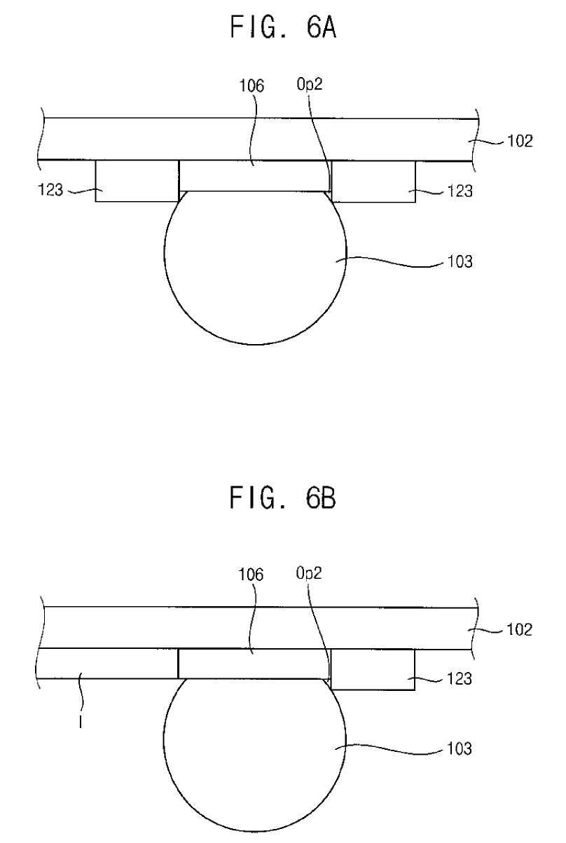

The lead-free solder 103 employed in the stacked semiconductor package 300 may be positioned in a peripheral region “P” to form a space “S” between the first PCB 102 and the second PCB 202. In order to form a space “Sa” between a lower face of the stacked semiconductor package 300 and an epoxy molding compound 205 of the BGA package 200 in which a semiconductor chip 201 is received, the lead-free solder 103 may have a diameter substantially larger than that of a solder 203 of the BGA package 200. In an example embodiment, the photo solder resist 123 may have an opening “Op2” having a width of about 0.3 mm as illustrated in FIGS. 6A and 6B. The lead-free solder 103 may have a diameter of about 0.42 mm. The diameter of the lead-free solder 103 may be adjusted by the width of the opening Op2 in a solder joint. The opening Op2 may be defined by sidewalls of the photoresist 123, a surface of the solder pad 106, and/or an isolation layer “I” illustrated in FIG. 6B. FIG. 6A illustrates an outermost lead-free solder 103, bordered on two sides by photo solder resist 123. FIG. 6B illustrates a second lead-free solder 103, bordered on one side by photo solder resist 123.

In example embodiments, the second PCB 202 may be a flexible substrate, a rigid substrate, etc. The second PCB 202 may include polyimide, an epoxy-based resin, polyethylene, etc. For example, the second PCB 202 may include the flexible substrate including polyimide or the rigid substrate including polyethylene or an epoxy-based resin, etc. The second PCB 202 also includes a photo solder resist 204 and solder pad 206.

In example embodiments, the lead-free solder may be employed in manufacturing a BGA package, a solid state drive (SSD), etc. as an external connection terminal. For example, the lead-free solder may be employed in a stacked semiconductor package or a multi-memory device as the external connection terminal. Therefore, an electronic device such as the stacked semiconductor package, the SSD, etc. which uses the lead-free solder having the above-mentioned content may have sufficient impact resistance and heat resistance to improve solder joint reliability.

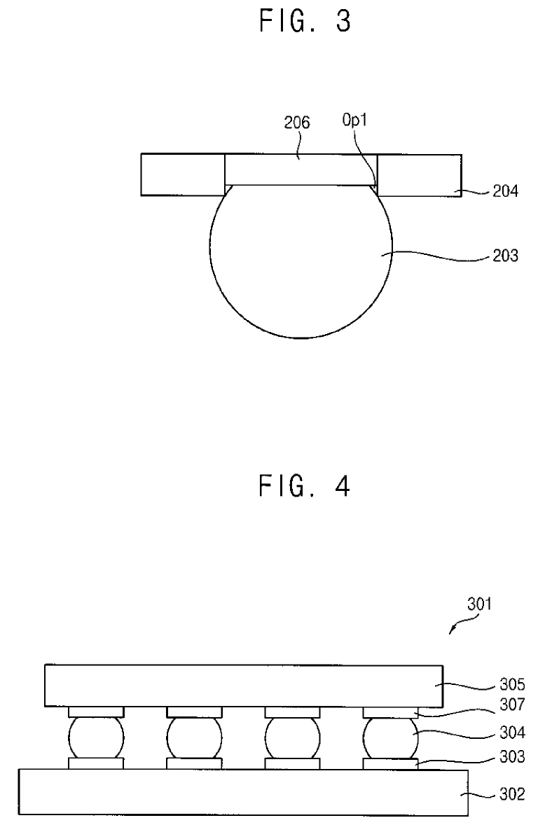

FIG. 3 is a cross-sectional view illustrating a lower solder joint in the stacked semiconductor package according to an embodiment of the present general inventive concept.

Referring to FIG. 3, when a solder pad 206 including copper is exposed to the atmosphere, copper may react with oxygen to form a compound including oxygen and copper. When the lead-free solder 203 is attached to the solder pad 206 exposed by an opening “Op1” of the photo solder resist 204, the compound including oxygen and copper may deteriorate adhesion between the solder 204 and the solder pad 206. Thus, a water-soluble antioxidant may be coated on the solder pad 206 to prevent oxidation of the solder pad 206.

In an example embodiment, before the water-soluble antioxidant may be coated on the solder pad 206, a cleaning process or a soft etching process to remove an undesired material from the solder pad 206, may be performed to etch a surface of the solder pad 206 by a small thickness. For example, after a cleaning process or soft etching process is performed, the solder pad 206 may have a thickness of about 5 percent to about 30 percent less than that of the solder pad 206 prior to performing the cleaning process or the soft etching process.

The lead-free solder 203 may be mounted on a mobile-type motherboard in an infrared (IR) oven by a reflow process. Thus, the lead-free solder which includes about 3.5 percent by weight to about 6 percent by weight of silver, about 0.05 percent by weight to about 0.5 percent by weight of copper and a remainder of tin may be employed in a PCB on which the semiconductor package is mounted and have high impact resistance and heat resistance.

FIG. 4 is a cross-sectional view illustrating a semiconductor module according to an embodiment of the present general inventive concept.

Referring to FIG. 4, the semiconductor module 301 includes a main board 302, an integrated circuit (IC) chip 305 and a lead-free solder 304.

A circuit pattern (not illustrated) may be formed on the main board 302 and the circuit pattern may be electrically connected to a plurality of contact pads 303. A plurality of capacitors and resistors (not illustrated) may be mounted on the IC chip 305. An electrode pad 307, which electrically connects the IC chip 305 to an external connection terminal, is formed on a lower surface of the IC chip 305 and is arranged in a row. The IC chip 305 is electrically connected to the main board 302 by the lead-free solder 304. In example embodiments, the IC chip 305 may be a BGA package. For example, the IC chip 305 may include a semiconductor chip mounted on and electrically connected to a PCB on which a circuit pattern is formed. A mold resin (not illustrated) may mold an upper surface of the IC chip 305 and the electrode pad 307 arranged in a row may be formed on the lower surface of the IC chip 305.

The lead-free solder 304 may be formed using an alloy which includes about 3.5 percent by weight to about 6 percent by weight of silver, about 0.05 percent by weight to about 0.5 percent by weight of copper and a remainder of tin. The lead-free solder 304 may have a ball shape. The lead-free solder 304 is interposed between the contact pad 303 of the main board 302 and the electrode pad 307 of the IC chip 305 to electrically connect the contact pad 303 and the electrode pad 307. The lead-free solder 304 which includes less than about 0.5 percent by weight of copper and more than about 3.5 percent by weight of silver, may have sufficient impact resistance and superior heat resistance compared to those of a conventional solder including about 0.5 percent by weight of copper, about 1.0 percent by weight of silver and a remainder of tin. Thus, the number of drop impacts of the semiconductor module 301 having the lead-free solder 304 including the above-mentioned content may be about 105 times to about 211 times when a drop impact test is performed. The above-mentioned content of the lead-free solder 304 has already been previously described, so any further explanations will be omitted herein for brevity.

Hereinafter, example embodiments will be described below through Examples and Comparative Examples. However, it is understood that the present general inventive concept should not be limited to these examples but various changes and modifications can be made by one of ordinary skill in the art within the spirit and scope of example embodiments.

### EXAMPLE 1

A solder was formed using an alloy including about 5 percent by weight of silver, about 0.1 percent by weight of copper and a remainder of tin.

### EXAMPLE 2

A solder was formed using an alloy including about 4 percent by weight of silver, about 0.1 percent by weight of copper and a remainder of tin.

### COMPARATIVE EXAMPLE 1

A solder was formed using an alloy including about 3 percent by weight of silver, about 0.5 percent by weight of copper and a remainder of tin.

### COMPARATIVE EXAMPLE 2

A solder was formed using an alloy including about 2.5 percent by weight of silver, about 0.5 percent by weight of copper and a remainder of tin.

### COMPARATIVE EXAMPLE 3

A solder was formed using an alloy including about 1.2 percent by weight of silver, about 0.5 percent by weight of copper and a remainder of tin.

### COMPARATIVE EXAMPLE 4

A solder was formed using an alloy including about 1 percent by weight of silver, about 0.5 percent by weight of copper and a remainder of tin.

### COMPARATIVE EXAMPLE 5

A solder was formed using an alloy including about 3 percent by weight of silver, about 0.1 percent by weight of copper and a remainder of tin.

### COMPARATIVE EXAMPLE 6

A solder was formed using an alloy including about 2.0 percent by weight of silver, about 0.1 percent by weight of copper and a remainder of tin.

Evaluation of Impact Resistance

The impact resistance of the solders according to the Examples 1 and 2 and the Comparative Examples 1 to 6 was confirmed by a drop impact test. The drop impact test refers to a test in which a sample, on which a semiconductor package has been mounted, is loaded into equipment for the drop impact test. A sample is dropped from a predetermined height toward a rigid base to obtain an impact force applied to the sample from the rigid base.

PCB modules on which semiconductor packages were mounted by using solders according to Examples 1 and 2 and the Comparative Examples 1 to 6, respectively, were prepared. A drop impact test was performed on each of the PCB modules through the following operations. The PCB modules were dropped face down toward the ground to apply an impact generated by an acceleration of gravity of about 1,500 g/ms to the PCB modules. The PCB modules were repeatedly dropped until a first failure corresponding to cracking of an intermetallic compound layer between the solder and a solder pad in each of the semiconductor packages of the PCB modules is generated. The PCB modules were dropped about 200 times to about 250 times. The numbers of drop impacts of the PCB modules at which the first failures were generated were listed in Table 1.

TABLE 1

| | | Number of |
|---|---|---|
| | | Drop |
| | Solder Composition | Impacts |
| Example 1 | 5 percent by weight of silver, 0.1 percent | 211 |
| | by weight of copper and a remainder of tin | |
| Example 2 | 4 percent by weight of silver, 0.1 percent | 187 |
| | by weight of copper and a remainder of tin | |
| Comparative | 3 percent by weight of silver, 0.5 percent | 1 |
| Example 1 | by weight of copper and a remainder of tin | |
| Comparative | 2.5 percent by weight of silver, 0.5 percent | 12 |
| Example 2 | by weight of copper and a remainder of tin | |
| Comparative | 1.2 percent by weight of silver, 0.5 percent | 20 |
| Example 3 | by weight of copper and a remainder of tin | |
| Comparative | 1 percent by weight of silver, 0.5 percent | 22 |
| Example 4 | by weight of copper and a remainder of tin | |
| Comparative | 3 percent by weight of silver, 0.1 percent | 105 |
| Example 5 | by weight of copper and a remainder of tin | |
| Comparative | 2 percent by weight of silver, 0.1 percent | 25 |
| Example 6 | by weight of copper and a remainder of tin | |

As illustrated in Table 1, when the drop impact test was performed on the PCB module including the solder according to Comparative Example 1, a first failure was generated from a first drop impact. When the drop impact test was performed on the PCB modules including the solder according to Example 1, a first failure was generated from the 187th drop impact.

When the solder included about 0.1 percent by weight of copper, the number of drop impacts was increased as an amount of silver included in the solder was increased. When an amount of copper was reduced from about 0.5 percent by weight to about 0.1 percent by weight, the number of drop impacts was considerably increased.

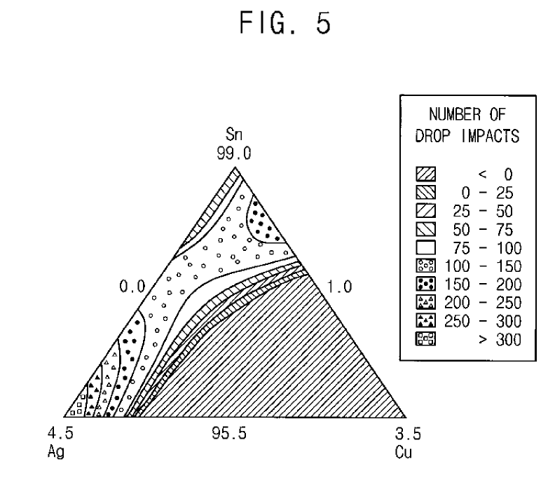

FIG. 5 is a graph illustrating the results of the drop impact test performed on a stacked semiconductor package according to the composition of a solder employed in the stacked semiconductor package. Referring to FIG. 5, a content of silver was in a range of about 1.0 percent by weight to about 4.5 percent by weight and a content of copper was in a range of about 0 percent by weight to about 3.5 percent by weight. A content of tin was in a range of about 95.5 percent by weight to about 99 percent by weight.

As illustrated in FIG. 5, when the solder included about 0.05 percent by weight to about 0.5 percent by weight of copper and more than about 3.5 percent by weight of silver, the number of drops was considerably increased. Thus, cracking of the intermetallic compound layer between the solder and the solder pad may be reduced in accordance with example embodiments.

Referring to Table 1 and FIG. 5, when the solder included about 0.5 percent by weight of copper, as the amount of silver was increased, the impact resistance of the solder was increased and also the heat resistance of the solder was decreased. When the solder included less than about 2 percent by weight of silver, as an amount of copper was reduced, the heat resistance and the impact resistance of the solder was deteriorated. Thus, as may be understood from the experimental results, when the solder includes about 3.5 percent by weight to about 6 percent by weight of silver and about 0.05 percent by weight to about 0.5 percent by weight of copper, the solder may have superior heat resistance and high impact resistance.

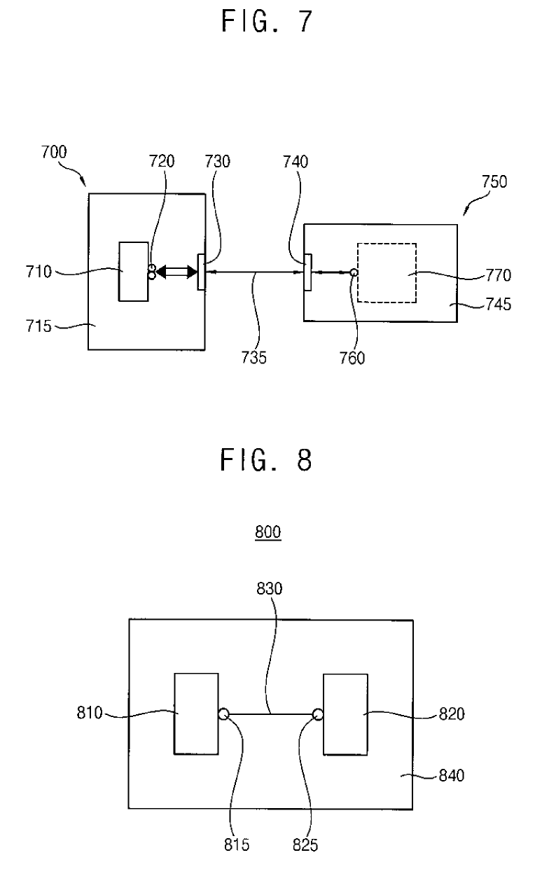

FIG. 7 illustrates an electronic apparatus 700 according to an embodiment of the present general inventive concept.

As illustrated in FIG. 7, lead-free solder balls of the present general inventive concept may be used in a variety of electronic devices and configurations. For example, an electronic apparatus 700 may be coupled with a memory unit 750. The electronic apparatus 700 may include a processing unit 710, mounted on a printed circuit board 715 that connects to a terminal 730 via lead-free solder balls 720 mounted on the processing unit 710. The lead-free solder balls 720 may be connected to input/output terminals (not illustrated) on the processing unit 710 to enable back and forth communication between the processing unit 710 and external devices. An example of an external device may be a memory unit 750, but other devices such as additional processors, logic circuits, power circuits, and the like, may be connected to the electronic apparatus 700 through electrical terminals 730 and 740. The memory or other electronic unit 750 may include a semiconductor package 770, an example of which is illustrated in FIG. 2, mounted on a printed circuit board 745, with at least one lead-free solder ball 760 connected between the semiconductor package 770 and electrical terminal 740. The electronic apparatus 700 and memory device 750 may be connected via a conductive line 735 to enable back and forth communication.

FIG. 8 illustrates an electronic apparatus 800 according to an embodiment of the present general inventive concept.

As illustrated in FIG. 8, lead-free solder balls may be used in electronic apparatus 800 including components mounted or attached to a single printed circuit board 840. In the electronic apparatus 800, a processing unit 810 may connect to a semiconductor package 820 via at least one lead-free solder ball 815 attached to the processing unit 810 and via at least one lead-free solder ball 825 attached to a semiconductor package 820. An example of the semiconductor package 820 is illustrated in FIG. 2 herein. The processing unit 810 and semiconductor package 820 may also be connected by way of a conductive line 830 to enable back and forth communication.

According to example embodiments, a lead-free solder formed using an alloy including less than about 0.5 percent by weight of copper and more than about 3.5 percent by weight of silver may have high impact resistance and good heat resistance. Therefore, abrupt changes of a thermal expansion coefficient caused by a temperature difference between a liquid state and a solid state and thermal modification of an electronic device employing the lead-free solder may be reduced to enable stable operation. Therefore, the lifespan of products employing the lead-free solder may be extended.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present general inventive concept. Accordingly, all such modifications are intended to be included within the scope of the present general inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

1-10. (canceled)

11. A method of manufacturing a semiconductor package, comprising:
preparing a first printed circuit board (PCB) having a first solder pad;
electrically connecting at least one semiconductor chip to the first PCB; and
mounting a first lead-free solder on the first solder pad, the first lead-free solder including silver (Ag) of about 3.5 percent by weight to about 6 percent by weight, copper (Cu) of about 0.05 percent by weight to about 0.5 percent by weight and tin (Sn) as a remainder.

12. The method of claim 11, further comprising electrically connecting a second PCB to the first lead-free solder, the second PCB including a second solder pad.

13. The method of claim 12, further comprising mounting a second lead-free solder on the second solder pad included in the second PCB.

14-17. (canceled)

18. A method of forming a semiconductor packaging apparatus, comprising:
forming a lead-free solder ball on a printed circuit board (PCB) with a semiconductor chip, wherein the lead-free solder ball comprises silver (Ag) of about 3.5 percent by weight to about 6 percent by weight, copper (Cu) of about 0.05 percent by weight to about 0.5 percent by weight; and tin (Sn) as a remainder.

19. A method of manufacturing a semiconductor package, comprising:
forming a layer of photo solder resist with at least one opening;
forming at least one solder pad within the at least one opening;
adhering a lead-free solder ball to the at least one solder pad; and
coating a water-soluble antioxidant on the at least one solder pad to prevent oxidation of the at least one solder pad.

20. A method of manufacturing a semiconductor package apparatus, comprising:
forming a plurality of first solder balls having a first diameter;
forming a plurality of first solder pads disposed over the plurality of first solder balls;
forming a first photo solder resist pattern interspersed between the plurality of first solder pads;
forming a printed circuit board disposed over the plurality of first solder pads;
forming a plurality of second solder pads disposed over the printed circuit board (PCB);
forming a second photo solder resist pattern interspersed between the plurality of second solder pads; and
forming a plurality of second solder balls having a second diameter substantially larger than the first diameter.
